(19) United States
(12) Patent Application Publication
(10) Pub. No.: US 2025/0260738 A1
(43) Pub. Date: Aug. 14, 2025

(54) Fuzzy logic based forwarding method and system for mitigation of push-based data broadcast in VNDN

(71) Applicant: Hoseo University Academic Cooperation Foundation, Asan-si (KR)

(72) Inventors: Huhn Kuk LIM, Daejeon (KR); Sajjad Ahmad Khan, Asan-si (KR)

(21) Appl. No.: 18/436,192

(22) Filed: Feb. 8, 2024

(51) Int. Cl. H04L 67/12; G06F 18/2337; H04L 45/16

(52) U.S. Cl. CPC H04L 67/12; G06F 18/2337; H04L 45/16

(57) ABSTRACT

A method for optimizing push-based data broadcasting in Vehicle Named Data Networks (VNDNs) is disclosed. The method introduces a novel approach to cluster vehicles and select Cluster Heads (CHs) using fuzzy logic. Each CH is responsible for broadcasting data packets within its cluster. The process involves determining the location of each vehicle, clustering them into groups, disseminating cluster information, and employing fuzzy logic to select CHs.

This method significantly mitigates data storm issues in VNDNs, ensuring smoother data transmission between vehicles, particularly during emergencies, enhancing both efficiency and reliability in data dissemination within VNDN environments.

### BACKGROUND OF THE INVENTION

### 1. Field of the Invention

The present invention relates to a fuzzy logic-based forwarding method and system for mitigating push-based data broadcasting in a vehicle named-data network, and more specifically, to a forwarding method and system for grouping vehicles into clusters and selecting a cluster head (CH) vehicle from each cluster using fuzzy logic, wherein the cluster head is solely responsible for broadcasting data packets within that cluster.

### 2. Description of the Related Art

Vehicular Named Data Networking (VNDN) is one potential future network structure that allows connected and autonomous vehicles (CAVs) to exchange data by simply distributing content over the network.

VNDN is a model that only supports pull-based data forwarding, where content information is forwarded upon data request. However, it is essential to design a push-based data delivery model to broadcast critical data without data requests in critical situations.

One of the challenges of push-based data forwarding in VNDN is to address the broadcast effect that occurs when all vehicles broadcast important information over the network. For example, in push-based data forwarding, in an emergency situation such as an accident, road hazard, or bad weather, a data producer generates a critical data packet and broadcasts it to all nearby vehicles. All vehicles would then broadcast the same critical data packets to each other, resulting in a broadcast storm in the network.

### SUMMARY OF THE INVENTION

The present invention was conceived to solve the above problems, and aims to provide a method and a system that enables data forwarding between vehicles to be carried out more smoothly by alleviating the data storm phenomenon caused by the broadcast of push-based data under a VNDN network.

To achieve this object, there is provided a method, by a fuzzy logic-based forwarding management system, for clustering and cluster head selection for data forwarding, comprising: (a) determining a location of each vehicle on a road; (b) grouping vehicles into clusters by a clustering process; (c) sending each vehicle information of a cluster it belongs to; (d) selecting a vehicle as a cluster head (CH) in each cluster to be responsible for data broadcasting using fuzzy logic; and, (e) sending, in each cluster, a notification to the vehicle selected as the cluster head that the vehicle has been selected as the cluster head.

According to other aspect of the present invention, there is provided a method, by a data forwarding control device installed in a vehicle, for data transfer and reception control between other vehicles during driving, comprising: (a) receiving and storing cluster information to which the vehicle corresponds from a fuzzy logic-based forwarding management system (hereinafter referred to as the “forwarding management system”); (b) receiving a notification from the forwarding management system indicating that the vehicle has been selected as a cluster head, or receiving information related to a cluster head from the vehicle selected as the cluster head; (c) perform step (d) in case of a critical event, or proceed to step (e); (d) generating a critical data packet, and transmitting the generated critical data packet to the cluster head vehicle of the cluster to which the vehicle belongs; and, (e) upon receiving a critical data packet, if the vehicle is a cluster head vehicle, broadcasting the received critical data packet to other vehicles in the cluster to which the vehicle belongs, or dropping the received critical data packet.

According to the present invention, when a broadcast of push-based data is performed in a VNDN network, it has the effect of alleviating a data storm phenomenon caused thereby, so that data forwarding between vehicles can be performed more smoothly.

### BRIEF DESCRIPTION OF THE DRAWINGS

FIG. 1 is a drawing to illustrate vehicular named data networking (VNDN).

FIG. 2A is a diagram depicting pull-based data forwarding.

FIG. 2B is a drawing depicting push-based data forwarding.

FIG. 3 is a drawing to illustrate the K-means clustering method for clustering of vehicles in push-based data forwarding in VNDN.

FIG. 4 is a block diagram representing the fuzzy logic used to select a cluster head (CH).

FIG. 5 is a diagram depicting a critical data forwarding scenario in push-based data forwarding using fuzzy logic.

FIG. 6 is a sequence diagram depicting how critical data is forwarded in push-based data forwarding using fuzzy logic.

FIG. 7 shows the total number of critical data packets generated in each iteration.

FIG. 8 shows the total number of critical data packets sent as the number of vehicles increases.

FIG. 9 shows the efficiency of the forwarding method.

FIG. 10 is a diagram depicting the total number of broadcast data packets according to vehicle density.

FIG. 11 is a diagram depicting the total number of broadcast data packets as the number of vehicles increases.

### DETAILED DESCRIPTION OF THE INVENTION

Hereinafter, exemplary embodiments of the present invention will be described in detail with reference to the accompanying drawings. Prior to the description of the present invention, it will be noted that the terms and wordings used in the specification and the claims should not be construed as general and lexical meanings, but should be construed as the meanings and concepts that agree with the technical spirits of the present invention, based on the principle that the concepts of the terms may be properly defined by the inventor(s) to describe the invention. Since the examples described in the specification and the configurations illustrated in the drawings are merely preferred embodiments of the present invention and cannot represent all the technical sprints of the present invention, it should be understood that various equivalents and modifications that may replace them can be present.

Terms containing ordinal numbers, such as first, second, etc., may be used to describe various components, but these terms are used only for the purpose of distinguishing one component from another and the corresponding components are defined by these terms. is not limited by Singular expressions include plural expressions unless the context clearly dictates otherwise.

Terms such as “comprise,” “comprise,” or “have” used in the specification should be understood to limit the presence of features, steps, components, or combinations thereof described in the specification, and one or more other This is not to exclude the possibility that features, steps, components, or combinations thereof may exist or be added.

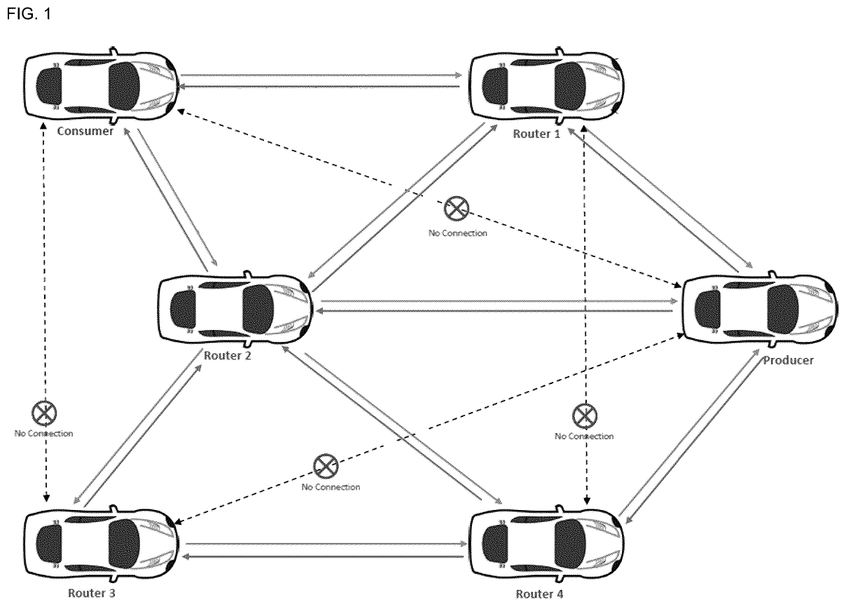

FIG. 1 is a diagram to illustrate vehicular named data networking (VNDN). The Information-Centric Network (ICN) project called Named Data Networking (NDN) is a new architecture designed to upgrade existing TCP and IP networks to content-based networks. The main purpose of the network modification is to allow data packets in the communication network to easily refer to the name of the content instead of the destination IP address.

Most recent research has focused on vehicular communication and its integration with NDN architectures, namely Vehicular Named Data Networking (VNDN). VNDN is an application class of VANETs and NDNs in which groups of vehicles are connected via On-Board Units (OBUs). OBUs enable vehicles to process, store, and communicate with each other. OBUs can also be wirelessly connected with or without Road Side Units (RSUs), which can form ad hoc, dispersed, and self-organized networks.

The main objective of VANETs using the NDN architecture is to provide strict information exchange and improve road safety while enhancing the driving experience. In a VNDN, vehicles can communicate and exchange interest packets and subsequent data packets via V2V and V2RSUs.

When a data consumer vehicle needs content, it creates a interest packet with the name of the content and broadcasts it across the network. The intermediate vehicle will broadcast again until the interest packet reaches the data producer. Once the interest packet reaches the node/vehicle that owns the requested data, the data is sent to the data consumer vehicle that requested it. In this case, owning the requested data means that the names of the data owned or the prefixes of the data owned are identical to the names of the requested data.

Since VNDN packets do not have an origin and destination address, intermediate vehicles use the “name” and “prefix” in data structures such as the Content Store (CS), Pending Interest Table (PIT), and Forwarding Information Base (FIB) to exchange request and data packets.

FIG. 1 shows a typical method used in a VNDN-based architecture, where the third layer uses content names instead of IP addresses.

The following describes the aforementioned CS, PIT, and FIB data structures.

### Content Store (CS)

A Content Store (CS) is one of the important data structures used in VNDN-based communication. When a CS receives a data packet from a data producer vehicle or an intermediate vehicle, it temporarily stores the data packet. In VNDN-based communication, data packets are meaningful and need to be stored in a cache, i.e., in the CS, where they can be delivered to data consumers. To maintain an updated version, the most recently used data packet replaces the last one. When a vehicle receives a interest packet, it checks the CS for the corresponding data packet.

### Pending Interest Table (PIT)

Pending Interest Table (PIT) is another data structure in the VNDN architecture. A PIT contains all interest packets received and forwarded in the search for data packets. Each PIT records the name or prefix of the data accompanying the interest packet on the incoming or outgoing interface. After successfully delivering a data packet, it is removed from the PIT table.

### Forwarding Information Base (FIB)

Forwarding Information Base (FIB) is a data structure used in the VNDN architecture. FIB creates a routing table that associates content names with interfaces. A name-prefix-based routing protocols populate the FIB, which can have many output interfaces for each prefix.

### Data Consumer Vehicle

In a VNDN, any node/vehicle that generates a interest packet for any content or information is a data consumer vehicle. Based on this NDN forwarding strategy, a data consumer initiates the interest packet and broadcasts it to all its neighbors. If the request is filled by an intermediate vehicle or data producer, the corresponding data packet is received. Thus, a consumer vehicle is a data requester in a VNDN system.

### Data Producer Vehicle

In the VNDN, the node or vehicle that holds the original data in storage is the data producer. When a data producer receives a interest packet, it matches the name or prefix of the content and prepares the data packet. The data is then forwarded to the data consumer via the same path that the interest packet traveled.

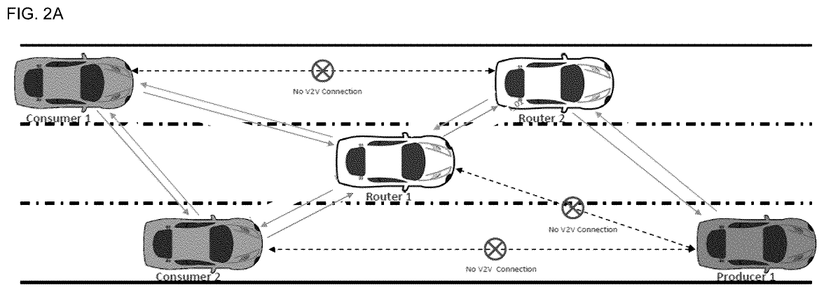

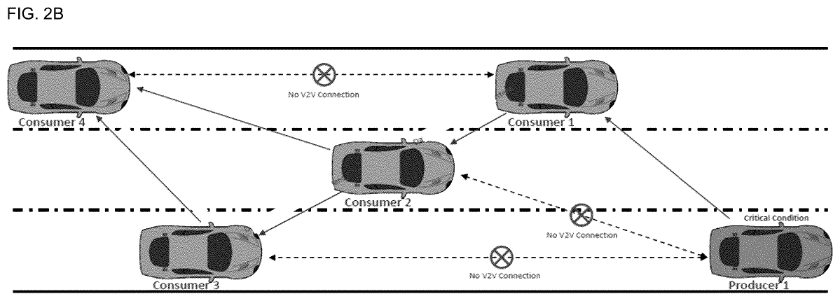

FIG. 2A is a diagram illustrating pull-based data forwarding, and FIG. 2B is a diagram illustrating push-based data forwarding.

The VNDN basically supports a pull-based architecture in which communication is initiated by a consumer node/vehicle. However, in vehicular communication, there might be some critical situations in which push-based communication should be applied. These critical situations may include the broadcast of traffic information, advertisements, and critical alerts. FIGS. 2A and 2B illustrate the pull-based and push-based data delivery mechanisms in VNDN, respectively.

The VNDN is represented by the undirected graph Gt(V, ∈t). where V is the collection of vertices and ∈t represents the links connecting the vehicles at time t. V represents the connected vehicles in the network, such as v1, v2, v3, . . . , vN. P is the data producer that holds the original content. And c is a data consumer who wants to acquire that content. O represents an object of the content with two different types of chunks. In the following, the term “chunk” is used to refer to a bundle of data.

The non-critical chunks consist of n1, n2, n3, . . . , nK, and the critical chunks consist of r1, r2, r3, . . . , rM. Using Equation 1, we can calculate the total transfer time of a data packet in a pull-based VNDN system. We assume that all chunks have the same size regardless of class, denoted by sr.

$${T}_{TCT} ( {G}_{t α} , {G}_{tI} , {G}_{tr} , p , c ) = Q ( {G}_{t α} , p , c ) {t}_{α} + Q ( {G}_{tI} , p , c ) [ {\sum }_{k = 1}^{M} ( {t}_{y} + \frac{{S}_{I}}{{τ}_{y}} ) ] + Q ( {G}_{tr} , p , c ) [ {\sum }_{l = 1}^{N} ( {t}_{x} + \frac{{S}_{r}}{{τ}_{x}} ) ] \qquad [ Equation 1 ]$$

where tx and _{T}x represent the latency and transfer rate of data chunks, while ty and _{T}y represent the latency and transfer rate of interest packets. Q(n1, n2) is the distance between two nodes (vehicles). Gtα represents the network status at the moment when the data producer broadcasts the data content.

Gtl defines the network conditions at the moment when the interest packet is broadcast. Gtr represents the network conditions at the moment when a chunk of data content is distributed. SI and Sr represent the length of the interest packet and data packet, respectively. tα represents the time required for a node/vehicle to forward a data packet to a neighboring node/vehicle. On the other hand, in the push-based communication model, Equation 2 can be used to calculate the total transfer time for critical data packets.

$$[ Equation 2 ]$$

$${T}_{STT} ( {G}_{t β} , {G}_{tr} , p , c ) = Q ( {G}_{t β} , p , c ) {t}_{β} + Q ( {G}_{tr} , p , c ) [ {\sum }_{l = 1}^{N} ( {t}_{x} + \frac{{S}_{r}}{{τ}_{x}} ) ]$$

where tx and _{T}x denote the latency and transfer rate for a chunk of critical data content. Q(n1, n2) denotes the distance between two nodes (vehicles). Gtβ denote the network state at the moment when the data producer broadcasts the critical data content. Gtr represents the network status when a data producer transmits a chunk of critical data content. Sr represents the size of the critical data content. tβ is the time required for a node/vehicle to forward a critical data packet to a neighboring node/vehicle.

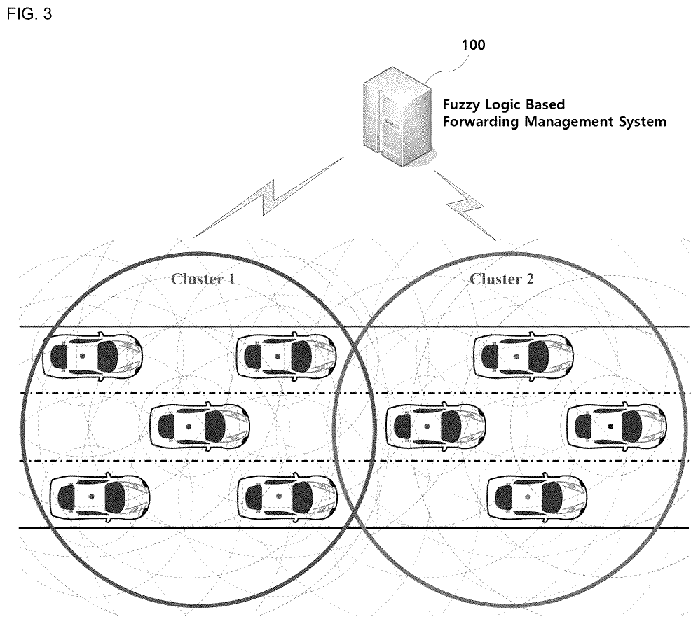

FIG. 3 is a diagram to illustrate the K-means clustering method for clustering of vehicles in push-based data forwarding in VNDN.

To alleviate the broadcast storm of critical data packets, the present invention proposes a push-based data forwarding technique using fuzzy logic. Hereinafter, referring to FIG. 3 to FIG. 5, the push-based data forwarding technique using fuzzy logic will be described in each step.

The first step in the push-based data forwarding technique using fuzzy logic of the present invention is the K-means clustering step.

The term “clustering” can be used to manage the frequent communication between vehicles. To organize vehicles into groups, a K-means clustering approach is employed.

This K-means clustering process is performed by an external system that communicates wirelessly with the traveling vehicles and is constantly aware of their locations, which will be referred to hereinafter as the “fuzzy logic-based forwarding management system 100” or simply “forwarding management system 100”.

K-means is an unsupervised machine learning approach that can be used for clustering. K-means is a technique that automatically separates vehicles into clusters or groups. Every vehicle is automatically assigned to a cluster when it receives its Received Signal Strength Indicator (RSSI) value, and each vehicle can only belong to one cluster. The center point of that cluster is called the “centroid”.

Initially, the algorithm determines the number of clusters ‘K’, and then ‘K’ points are randomly selected as centroids for each cluster. To find the optimal number for ‘K’, an Elbow algorithm can be used in one embodiment. Vehicles are grouped based on the centroid.

In the next step, central points are selected to represent the new centroids, and the vehicles are grouped along the new centroids. This process continues until there is no change in the groups.

FIG. 3 shows an embodiment of clustering using the K-means clustering algorithm. The K-means algorithm follows the expected maximization to solve the problem. It repeats these steps every second, assigning vehicles' location to the nearest cluster.

In this way, the forwarding management system 100 wirelessly transmits information about which cluster each vehicle is assigned to each vehicle. Each vehicle receives and stores the information, so that during future driving, each vehicle participates in the data transfer and reception process with knowledge of the cluster to which it belongs.

Of course, through the iterative clustering process described above, each vehicle continuously updates its cluster information whenever it receives changed cluster information from the forwarding management system 100.

Each step computes a new centroid for each cluster. The normalized function ‘J’ is computed using Equation 3.

$$J = {\sum }_{i = 1}^{m} {\sum }_{k = 1}^{K} {ω}_{ik} {‖ \vert {x}_{i} - {μ}_{i} \vert ‖}^{2} \qquad [ Equation 3 ]$$

where ωik=1 if the data xi belongs to cluster K; otherwise, ωik=0. Also, μk is the centroid of each xi cluster. Meanwhile, the normalized distance from the centroid is calculated according to Equation 4.

$$dist = \sqrt{{( {x}_{2} - {y}_{1} )}^{2} + {( {x}_{2} - {y}_{2} )}^{2}} \qquad [ Equation 4 ]$$

where x and y are the coordinates of each vehicle.

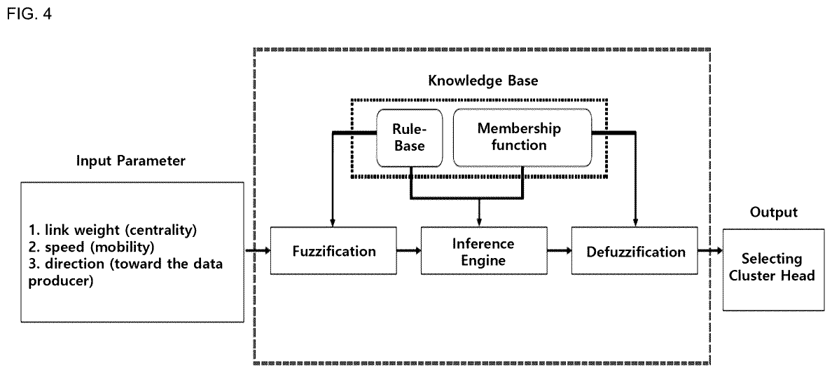

FIG. 4 is a block diagram showing the fuzzy logic used to select a cluster head (CH).

The second step of the push-based data forwarding technique using fuzzy logic of the present invention is a cluster head (CH) selection process using fuzzy logic, as shown in FIG. 4.

This cluster head selection process, like the K-means clustering process, is also performed by the fuzzy logic-based forwarding management system 100 described above, or “forwarding management system 100” for short. In other words, the forwarding management system 100 selects a vehicle in each cluster to be the cluster head through the fuzzy logic process described below, and wirelessly transfers a message to the vehicle that it has been selected as the cluster head. Upon receiving the message, the vehicle stores that it is the cluster head vehicle and also sends a message to the other vehicles in the cluster indicating that it is the cluster head vehicle.

This fuzzy logic cluster head selection process can be performed repeatedly as each cluster is updated. Or, even if the cluster is not updated, as the driving information of the vehicles in that cluster changes, the cluster head may change accordingly.

In the present invention, fuzzy logic is a strategy for determining and selecting cluster heads using two or more parameters. In the proposed method, the membership function is maintained and fuzzy rules are applied during the selection process.

During the fuzzification process, the fuzzy system converts the input values into fuzzy values. The input parameters are described below.

The inference engine takes input parameters and generates fuzzy output based on the fuzzy rules.

In the subsequent defuzzification, the calculated output value is converted into actual value, and cluster heads are selected based on the converted output value.

The input parameters described below are used to select a cluster head from a given cluster.

### 1) Link Weight (Centrality)

Link weight is an important parameter when selecting a cluster head from a cluster. In this step, the distance from the center point to all nodes/vehicles is calculated using the normalized distance expression, Equation 5.

$${dist}_{vi} = [ norm ( \sqrt{{( {x}_{2} - {x}_{1} )}^{2} + {( {y}_{2} - {y}_{1} )}^{2}} ) ] \times 100 \qquad [ Equation 5 ]$$

The shortest distance from the center position is given a higher weightage and is selected as the cluster head. However, other parameters also influence the selection process.

### 2) Speed (Mobility)

The speed of a node/vehicle is also an important parameter for selecting a cluster head. If the speed is higher, the vehicle moves faster and changes its position frequently. Therefore, the speed of a node/vehicle affects the control system, especially the fuzzy logic controller. The speed and mobility of nodes/vehicles can be calculated by Equation 6.

$${speed}_{vi} ( m / s ) = ( \frac{{speed}_{vi}}{{max}_{i = 1}^{n} speed} ) \times 100 \qquad [ Equation 6 ]$$

The speed vi of each vehicle is normalized by dividing by the maximum speed. The percentage values of all the speeds are then forwarded to the fuzzy logic controller.

### 3) Direction (Toward Data Producer)

This step takes the slope to find the direction of the node/vehicle. If the slope is zero (0) degree, the node/vehicle is assumed to be traveling toward the data producer of the critical data packet. If the slope is 180 degrees, the node/vehicle is assumed to be traveling in the opposite direction. Nodes/vehicles with a slope of 180 degrees that are traveling in the opposite direction from the data producer of the data packet are not eligible for cluster head election.

Equation 7 is used for the direction of the vehicle.

$${slope}_{vi} = \{ \begin{matrix}1 , & if {slope}_{vi} = 0 \\ 0 , & if {slope}_{vi} = 180\end{matrix} \qquad [ Equation 7 ]$$

### 4) Total Weight

After calculating the input values of the nodes/vehicles, the total weight for each node/vehicle in the cluster is obtained by Equation 8.

$${Total}_{vi} = ( {dist}_{vi} + {speed}_{vi} ) \times {slope}_{vi} \qquad [ Equation 8 ]$$

$$\begin{matrix}CH = {{min}^{n}}_{i} ( {Total}_{vi} ) , & CH \neq 0.\end{matrix} \qquad [ Equation 9 ]$$

Any node/vehicle with the minimum value can be selected as the cluster head for that cluster. The value must be greater than zero (0) in order to participate in the selection process.

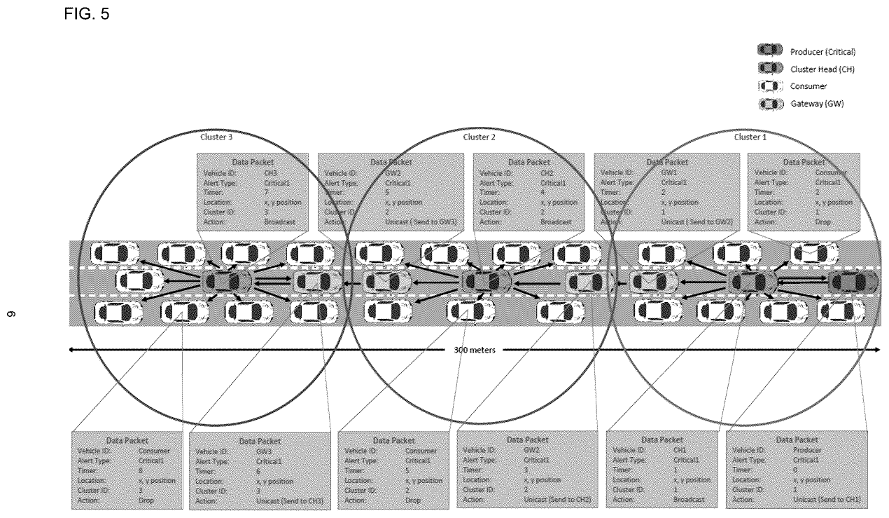

FIG. 5 is a diagram depicting a critical data forwarding scenario in push-based data forwarding using fuzzy logic.

First, the data packet format in push-based data forwarding using fuzzy logic of the present invention is described.

In the push-based data delivery scheme, the existing data packet format is modified and some additional information is inserted to distribute critical content.

In other words, some additional fields may be inserted to modify or update the data packet to control data broadcasting in the VNDN environment, which are described below. The important fields in the data packet are shown in Table 1 below.

TABLE 1
Field Name

Content
Data
Alert Type (Critical or Normal)
Location
Timer
Signature

Fields added in the data packet are as follows:

### 1) Alert Type

The alert type field of a data packet is an important field that can be used to understand the nature of the data packet. In critical scenarios, the alert will be labeled as ‘critical’. Therefore, after understanding the nature of the alert, the data consumer vehicle will forward the data packet without having an ‘interest request’ in their PIT table.

### 2) Location of the Data Producer

This field holds the location of the data producer when the data packet is generated. Using the location helps to know the direction of the critical data packet. The data consumer vehicle can use the location of the data producer to take action based on critical data packets. In other words, if the data consumer vehicle receives an alert from a data producer vehicle traveling in the same direction, it will take the necessary action in advance, and if the data producer vehicle is traveling in the opposite direction, it will ignore and drop the alert.

### 3) Timer

The timer also play an important role while distributing data packets in push-based data forwarding. The timer is used to forward data packets for a specific amount of time. When the timer reaches the maximum time, the data packet is dropped and data forwarding is stopped by the intermediate vehicles.

Data forwarding technique for data producers is as follows: Clustering for each vehicle traveling and selection of a cluster head for each cluster is performed by the forwarding management system 100 as described above. Thereafter, the data forwarding process between each vehicle, as described below, is performed by a data forwarding control device installed on each vehicle.

In a critical situation, push-based data packets are generated by the data producers and forwarded to the cluster head (CH) using Algorithm 1 below. Every vehicle advertises to all its neighbors about its driving information such as its location, speed and direction. In the fuzzy logic process, every node/vehicle in the cluster identifies its cluster head and cluster gateway (GW). Therefore, it is assumed that the data producer belongs to one cluster and has established a connection with its cluster head. When the data producer receives a regular interest packet for non-critical data, it generates an ordinary data packet and forwards it to the requesting vehicle.

However, in the event of a critical situation, the data producer generates a critical data packet and forwards it to the cluster head of the cluster. Only the cluster head is responsible for broadcasting the critical data packet to all member vehicles in the cluster. Algorithm 2 below expresses the pseudo-code for the cluster head and gateway vehicles.
Algorithm 1: Push-based critical data forwarding algorithm at a data producer Possible events: (Startup, interest i, consumer c, critical content b)

### Case Event:

```
if Producer==New then
  advertise each non-critical content Object O
  if critical content r then
    construct a critical data packet b
    send critical content b towards CH
  end if
end if
```

Algorithm 2: Push-based critical data forwarding algorithm at a data consumer Received Data Packet: (ID, Content, Alert Type, Location, Timer, Signature)

```
if Alert Type==bi (critical data packet) then
  read b
  if Vehicle (vi)== CH (Cluster Head) then
    Broadcast bi
  else if Vehicle (vi)== GWi then
    Forward b to GWi+1
  else
    drop b
  end if
end if
```

Data forwarding technique for data consumers is as follows:

Push-based data forwarding assumes that all vehicles are data consumer vehicles, and that critical data content is important to those data consumer vehicles. Therefore, critical data packets are forwarded to the cluster head of the cluster without receiving any interest packets.

Every member vehicle in the cluster have a MAC table and cluster information such as cluster head (CH) and gateways (GWs). When a critical data packet is received, the cluster head broadcasts the critical data packet to all member vehicles in the cluster. If the intermediate vehicle is a gateway, it forwards the critical data packet to the gateway vehicles in neighboring clusters.

If a data consumer vehicle is just a member vehicle in the cluster, it drops the data packets it receives and does not forward them to any nearby vehicles.

Algorithm 2 describes the data forwarding procedure followed by the cluster head and intermediate vehicles in critical data situations.

Critical data forwarding procedure is as follows:

FIG. 5 shows the flow of critical data from the data producer to all other vehicles. Critical data packets, such as emergency alerts, are assumed to be needed by all vehicles moving toward the location of the critical event.

Before any critical event occurs, all vehicles are grouped into several clusters using the K-means cluster method as described above. The vehicles in each cluster are then assigned different roles using the fuzzy logic method as described above.

As shown in FIG. 5, the data packets associated with each vehicle are data packets generated by that vehicle. In other words, for example, the data producer in Cluster 1 creates a data packet to be sent to the cluster head (CH1) of Cluster 1 (Action field: Unicast (Send to CH1)) and sends it to the cluster head (CH1), which in turn creates a data packet to be “broadcast” to all vehicles in Cluster 1 (Action field: Broadcast) and broadcasts it.

In addition, the gateway (GW1) in cluster 1 creates a data packet to be sent to the gateway (GW2) in cluster 2 (Action field: Unicast (Send to GW2)) and sends it to the gateway (GW2).

Vehicles outside of Cluster 1 will generate a data packet with “Drop” in the Action field, which will be dropped instead of being sent to another vehicle.

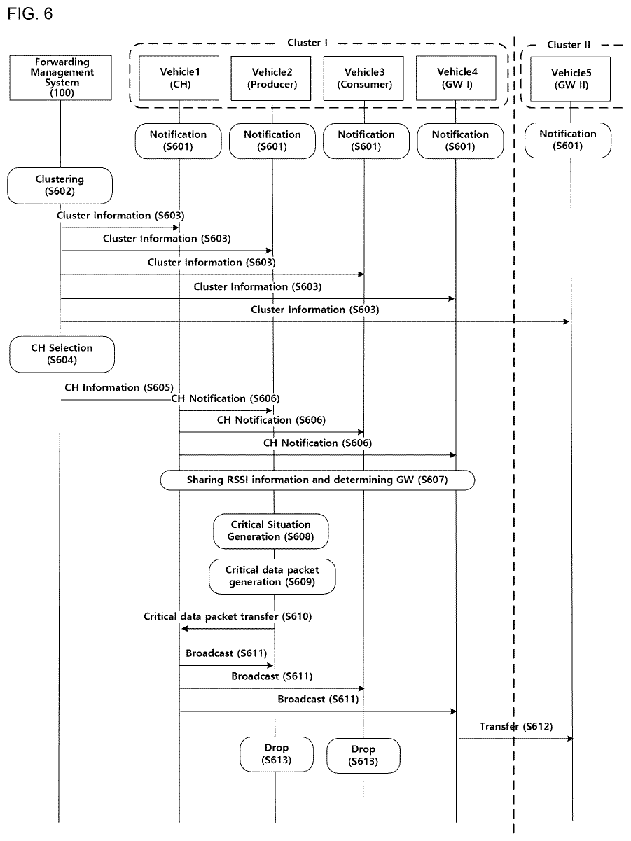

FIG. 6 is a sequence diagram of performing the critical data forwarding method in push-based data forwarding using fuzzy logic.

Since the push-based data forwarding method using fuzzy logic of the present invention has already been described in detail with reference to FIGS. 3 to 5, the push-based data forwarding method using such fuzzy logic will be briefly summarized in a sequential flow with reference to the sequence diagram of FIG. 6.

Also, as described above with reference to FIG. 5, after the clustering of each vehicle traveling and the selection of a cluster head for each cluster is performed by the forwarding management system 100, the data forwarding process between each vehicle is performed by a data forwarding control device installed on each vehicle.

First, each vehicle (vehicle 1 to vehicle 5) advertises its driving information, such as its location, speed, and direction, to all neighboring vehicles (S601). This driving information is also transferred to the aforementioned fuzzy logic-based forwarding management system (hereinafter referred to as the “forwarding management system”) 100 (S601).

For each vehicle, the forwarding management system 100 performs clustering in the manner described above with reference to FIG. 3, and provides information to each vehicle about which cluster each vehicle corresponds to (S603). Referring to FIG. 6, it can be seen that vehicles 1 to 4 belong to cluster I, and vehicle 5 belongs to cluster II.

In FIG. 6, the steps below are centered on Cluster I for convenience, but the same process is performed for the other clusters.

The forwarding management system 100 then performs, in each cluster, a cluster head (CH) selection process for that cluster (S604). This cluster head selection process may use a fuzzy logic process, as described above with reference to FIG. 4. Once a cluster head vehicle is selected in each cluster using the fuzzy logic process, a message is sent to that vehicle indicating that the vehicle has been selected as the cluster head (S605). Upon receiving the message, vehicle 1 notifies the other vehicles in the cluster, vehicles 2 through 4, that it is the cluster head (S606).

In each cluster, a gateway (GW) vehicle is then determined (S607). Which vehicle has been determined to be the gateway is automatically known to all vehicles by the RSSI value information as described above.

In other words, all vehicles in cluster I detect the RSSI levels of the signals from each vehicle in cluster I and neighboring clusters, and the values of the detected RSSI levels are shared among the vehicles in cluster I. In this case, the vehicle in cluster I whose signal has the largest RSSI is identified by all vehicles in the neighboring cluster as the gateway vehicle. At this time, with respect to the vehicle in the neighboring cluster with the largest RSSI, the vehicle in Cluster I with the largest RSSI level detected by the signal from that vehicle is identified by all vehicles as the gateway vehicle, because it is determined that it is the vehicle in Cluster I that is closest to the neighboring cluster.

When a critical situation occurs (S608), vehicle 2 detects it and generates a critical data packet to report the critical situation to the other vehicles (S609). Thus, vehicle 2 becomes a data producer vehicle and transmits the generated critical data packet to the cluster head vehicle (vehicle 1) (S610). This is because, in the data forwarding method of the present invention, only the cluster head performs the broadcast in order to mitigate the broadcast storm effect.

In this way, the cluster head vehicle (vehicle 1, CH) that receives the critical data packet from the data producer vehicle broadcasts the critical data packet to all vehicles in cluster I (S611).

The gateway vehicle (vehicle 4, GW I) of cluster I forwards the received critical data packet to the gateway vehicle (vehicle 5, GW II) of the neighboring cluster (cluster II) (S612).

Vehicles (Vehicle 2, Vehicle 3) other than the gateway of Cluster I that received the critical data packet will no longer forward the received critical data packet and drop it (S613).

The data producer generates critical data packets and sends them to the cluster head using Algorithm 1. The data producer sends the alert type, location, and a timer for that critical data packet. Once the cluster head receives the data, it broadcasts the critical data packet to all member vehicles in the cluster. When a critical data packet is received by a member vehicle in the cluster, that member vehicle discards the packet. The gateway, on the other hand, forwards the critical data packet to the next gateway in the nearest cluster.

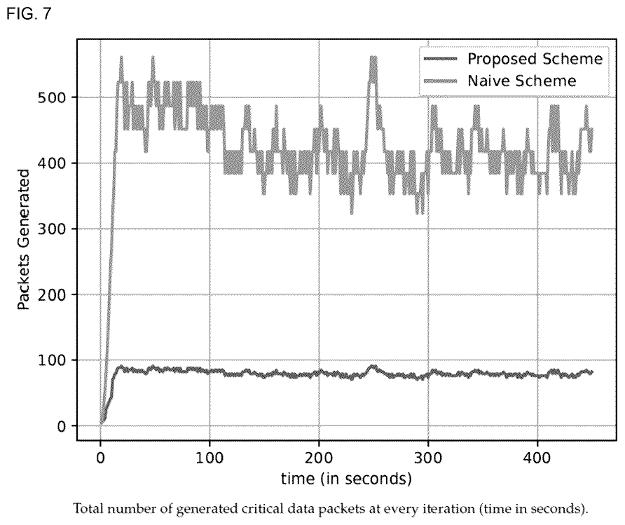

FIGS. 7 through 11 illustrate data forwarding simulation results. In particular, for the forwarding of push-based data packets in a VNDN, simulation results using a conventional simple forwarding method of push-based data packets (hereinafter referred to as the “conventional forwarding method”) and simulation results using a forwarding method of push-based data packets using the fuzzy logic of the present invention (hereinafter referred to as the “forwarding method of the present invention”) as described above with reference to FIGS. 3 to 6 are compared and shown in each of FIGS. 7 to 11. For a fair comparison, the simulations have the same configuration, i.e., the same network configuration, physical and MAC layer parameters, and mobility model. A total of 600 vehicles were considered traveling at different speeds. The length of the observation area was 300 meters and a three-lane road was considered. The rest of the simulation settings are listed in Table 2. In addition, a random number of vehicles (especially data producers) were evenly distributed throughout the network, and each vehicle was allowed to randomly generate critical data packets during the experiment. All vehicles were required to exchange their locations with all their neighbors via pilot messages.

TABLE 2

| Parameter | Value |
|---|---|
| Simulator | NS-3 and ndnSIM |
| Mobility Model | SUMO |
| Network Size | 1-50 vehicles |
| Poisson Point Distribution (λ) | 20 |
| Covered Area | 300 m |
| Transmission Range (m) | 100 |
| Vehicle Speed | 30-180 KM/H |
| Transmission Mode | V2V (IEEE 802.11p) |
| Alpha (α) | 0.50 |

Hereinafter, the simulation results of the forwarding method of the present invention and the conventional forwarding method will be described with reference to each of FIGS. 7 through 11.

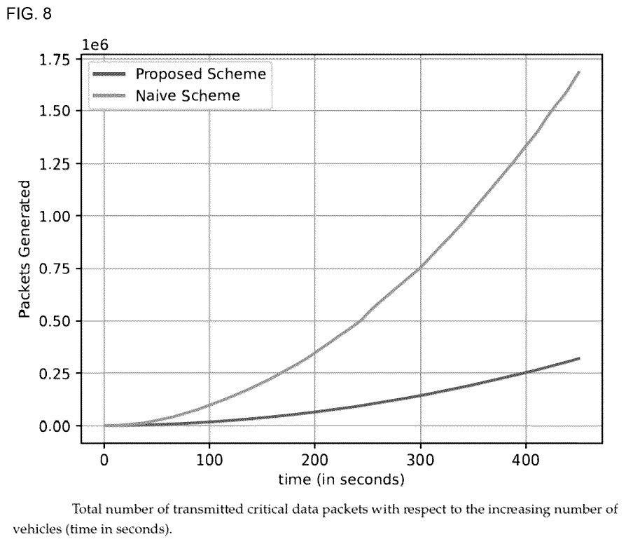

FIG. 7 is a plot of the total number of critical data packets generated in each iteration versus the number of vehicles, and FIG. 8 is a plot of the total number of critical data packets transmitted as the number of vehicles increases. Referring to FIG. 7, it can be seen that a large amount of important data packets are transmitted in the conventional forwarding method (Naive scheme), while a smaller amount of important data packets are transmitted in the proposed forwarding method (Proposed scheme).

In conventional forwarding methods, every vehicle that receives a data packet participates in broadcasting that data packet. As a result, all vehicles receive multiple copies of the same critical data packet. On the other hand, the inventive forwarding method allows only the cluster head to broadcast the important data packet to all vehicles in the cluster. Therefore, the inventive forwarding method transmits fewer data packets than the conventional forwarding method.

Referring to FIG. 8, it is noteworthy that the number of data packets by data producer vehicles increases over time. After the simulation starts, only one vehicle produces and sends critical data packets.

At 10 seconds after the start of the simulation, the two vehicles have generated and transmitted the critical data packets, and the process continues. By the time the simulation reaches 100 seconds, about 98,000 and 18,000 critical data packets have been generated and transmitted in the conventional forwarding method and the forwarding method of the present invention, respectively. The difference is increasing as the number of vehicles generating critical data packets increases. At 200 seconds after the simulation starts, the total number of data packets generated and transmitted by the conventional forwarding method and the forwarding method of the present invention increases to nearly 350,000 and 6500, respectively. Therefore, the total number of critical data packets transmitted is increased by the number of vehicles generating critical data packets. These results of FIGS. 7 and 8 show that the forwarding method of the present invention transmitted obviously fewer critical data packets than the prior art forwarding method.

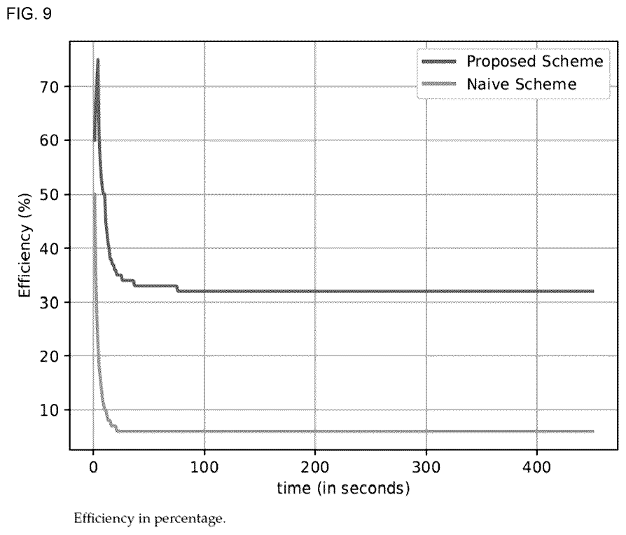

FIG. 9 is an illustration of the efficiency of the forwarding method.

FIG. 9 shows the efficiency of the forwarding method of the present invention and the prior art forwarding method. The efficiency is calculated using Equation 10. From FIG. 9, it can be seen that the efficiency of the inventive forwarding method is higher than the efficiency of the conventional forwarding method. As the number of vehicles increases, the efficiency decreases.

$$Efficiency ( \% ) = \frac{RequiredDataPackets}{TotalTransmittedDataPackets} \times 100 \qquad [ Equation 10 ]$$

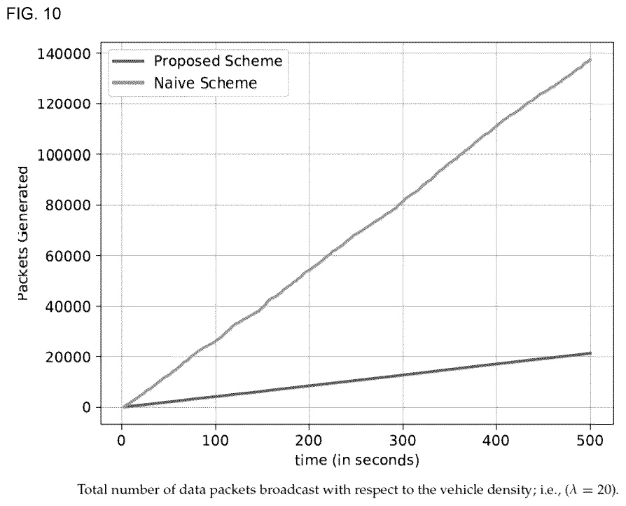

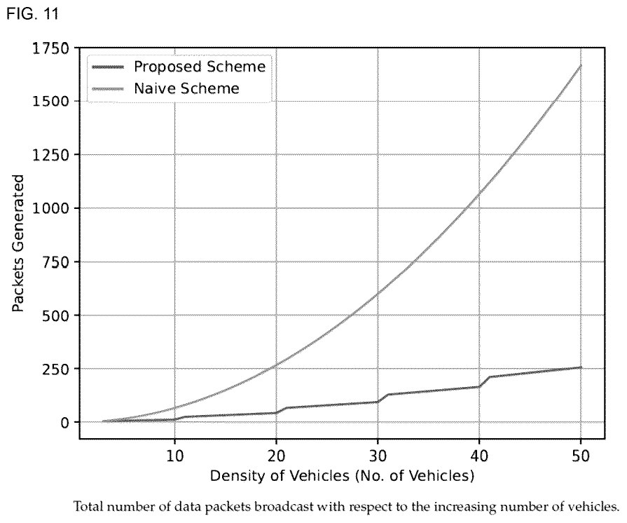

FIG. 10 is a plot of the total number of broadcast data packets as a function of vehicle density, and FIG. 11 is a plot of the total number of broadcast data packets as the number of vehicles increases.

In FIG. 10, we can see that the number of critical data packets increases linearly with time. However, the number of vehicles is randomly distributed by applying a Poisson point distribution with a mean value of 20 (λ=20).

Referring to FIG. 10, the inventive forwarding method broadcasts a much smaller number of critical data packets. In contrast, the prior art forwarding method broadcasts a very large number of critical data packets. The main reason for this is that in the inventive forwarding method, only the cluster head is responsible for broadcasting to all member vehicles in the cluster. However, in the conventional forwarding method, all vehicles broadcast important data packets, which causes a broadcast storm in the process of push-based data distribution. Therefore, the forwarding method of the present invention mitigates the broadcast storm effect in the process of push-based data forwarding in the VNDN environment.

Referring to FIG. 11, as the number of vehicles increases, the total number of data packets broadcast also increases. The ratio between the forwarding method of the present invention and the conventional forwarding method increases as the number of vehicles increases. In the prior art forwarding method, the broadcast of critical data packets is directly proportional to the number of vehicles. In contrast, in the forwarding method of the present invention, the number of critical data packets is proportional to the number of clusters and cluster heads. As the density of vehicles increases, the number of clusters and cluster heads increases. As a result, the broadcast storm is mitigated because the cluster head is responsible for broadcasting the critical data packets.

Based on the above, we can conclude as follows:

In VNDN, pull-based communication is natively supported, i.e., when a data consumer needs content, it generates an interest packet and broadcasts it to its neighbors. An intermediate vehicle (router) receives the interest packet, checks for content in its CS, adds the content to its PIT with an interface number, and broadcasts it to its neighbors until it reaches the data producer. The data producer uses the same route to deliver the content to the requesting data consumer. On the other hand, in push-based forwarding in VNDN, the data producer generates important content and broadcasts it to all neighboring vehicles without any request. However, this leads to a broadcast storm effect in the network. Therefore, this invention uses fuzzy logic techniques to mitigate the broadcast storm.

Consider an environment where a critical situation occurs when a data producer broadcasts useful information to the rest of the fleet.

The present invention uses a K-means clustering algorithm to divide the vehicles into groups. An Elbow algorithm can be used to determine the optimal number of clusters. It also uses fuzzy logic to select the cluster head (CH). After the cluster head selection process, the data producer sends the critical data packets to the cluster head only, and only the cluster head broadcasts the critical data packets to all the member vehicles inside the cluster. In addition, the gateway (GW) vehicles forward the data packets to the gateway vehicles of neighboring clusters.

As a result, the number of critical data packets sent is efficiently mitigated. The simulation results show that the forwarding scheme of the present invention transmitted fewer data packets and reduced the occurrence of broadcast storms. In addition, as the number of vehicles increased, the total number of transmitted critical data packets also increased. For example, when there are 50 vehicles, the total number of transmitted data packets is 1700 in the conventional forwarding method and 250 in the forwarding method of the present invention. In terms of efficiency, the forwarding method of the present invention achieved an efficiency of more than 30%, while the conventional forwarding method showed an efficiency of 10% or less.

The foregoing detailed description should not be construed as limiting in any respect and should be considered illustrative. The scope of the present invention should be determined by reasonable interpretation of the appended claims, and all changes within the equivalent scope of the present invention are included in the scope of the present invention.

What is claimed is:

1. A method, by a fuzzy logic-based forwarding management system, for clustering and cluster head selection for data forwarding, comprising:
(a) determining a location of each vehicle on a road;
(b) grouping vehicles into clusters by a clustering process;
(c) sending each vehicle information of a cluster it belongs to;
(d) selecting a vehicle as a cluster head (CH) in each cluster to be responsible for data broadcasting using fuzzy logic; and,
(e) sending, in each cluster, a notification to the vehicle selected as the cluster head that the vehicle has been selected as the cluster head.

2. The method of claim 1, wherein step (b) includes:
(b1) setting a number of clusters;
(b2) selecting center points to represent the centroids and grouping vehicles along closest centroids;
(b3) selecting new center points as centroids and grouping vehicles along new closest centroids; and,
(b4) repeating the above step (b3) and setting each group as a cluster when there are no changes in the groups.

3. The method of claim 1, wherein step (d) includes:
(d1) converting input values to fuzzy values;
(d2) generating fuzzy output from an inference engine according to a fuzzy rule;
(d3) converting the fuzzy output to a real value; and,
(d4) selecting cluster heads based on the real value in step (d3).

4. The method of claim 3, wherein the input value includes: weight for a distance of each vehicle from the center point (hereafter referred to as “link weight”); speed of each vehicle; and, direction of travel for each vehicle.

5. The method of claim 4, wherein the link weight is a normalized distance of each vehicle from the center point.

6. The method of claim 4, wherein the speed is the speed of that vehicle, normalized by a maximum speed of a vehicle in that cluster.

7. The method of claim 4, wherein, If a vehicle is traveling in the opposite direction from data producer of a critical data packet, the vehicle is not eligible for cluster head selection, and wherein a vehicles with a minimum sum of the link weight and spped is selected as the cluster head.

8. A method, by a data forwarding control device installed in a vehicle, for data transfer and reception control between other vehicles during driving, comprising:
(a) receiving and storing cluster information to which the vehicle corresponds from a fuzzy logic-based forwarding management system (hereinafter referred to as the “forwarding management system”);
(b) receiving a notification from the forwarding management system indicating that the vehicle has been selected as a cluster head, or receiving information related to a cluster head from the vehicle selected as the cluster head;
(c) perform step (d) in case of a critical event, or proceed to step (e);
(d) generating a critical data packet, and transmitting the generated critical data packet to the cluster head vehicle of the cluster to which the vehicle belongs; and,
(e) upon receiving a critical data packet, if the vehicle is a cluster head vehicle, broadcasting the received critical data packet to other vehicles in the cluster to which the vehicle belongs, or dropping the received critical data packet.

9. The method of claim 8, further comprise between steps (b) and (c):
(b1) identifying a gateway vehicle information within the cluster to which the vehicle belongs.

10. The method of claim 9, wherein the step (b1) includes:
(b11) detecting RSSI values generated by vehicles belonging to neighboring clusters;
(b12) receiving, from vehicles belonged to the the same cluster, RSSI values detected for vehicles in the neighboring clusters; and
(b13) identifying a vehicle detected the largest RSSI value in step (b11) and step (b12) as a gateway vehicle of the cluster to which the vehicle belongs, and storing the same.

11. The method of claim 10, wherein, upon receiving a critical data packet in step (e), the gateway vehicle transfers the received critical data packet to a gateway vehicle in the neighboring cluster.

12. The method of claim 8, wherein step (d) includes:
(d1) generating critical data packets; and,
(d2) if the vehicle is the cluster head vehicle, broadcasting the critical data packet to other vehicles in the same cluster, or transferring the critical data packet to the cluster head vehicle of the same cluster.
